(19) United States
(12) Patent Application Publication
(10) Pub. No.: US 2026/0099990 A1
(43) Pub. Date: Apr. 9, 2026

(54) THREE-DIMENSIONAL VARIABLE PERSPECTIVE RADIANCE FIELD VIEWING

(71) Applicant: d3Labs Inc., Moultonborough, NH (US)

(72) Inventors: Barry Spencer, Moultonborough, NH (US); Jeremy Egenberger, Pioneertown, CA (US); Calvin Spencer, Moultonborough, NH (US); Julian George Spencer, Moultonborough, NH (US)

(21) Appl. No.: 19/348,574

(22) Filed: Oct. 2, 2025

Related U.S. Application Data
(60) Provisional application No. 63/703,696, filed on Oct. 4, 2024.

(51) Int. Cl. G06T 15/20; G06T 7/579

(52) U.S. Cl. CPC G06T 15/20; G06T 7/579; G06T 2200/24; G06T 2210/56

(57) ABSTRACT

Embodiments of the present disclosure include a computer-implemented method for displaying three-dimensional viewing content based on a user perspective, the method comprising: receiving point cloud data by one or more structure from motion tools; creating a Gaussian splat scene by associating Gaussian splats with the point cloud data; generating two-dimensional raster images from the Gaussian splat scene; deriving a view matrix from a user position in a three-dimensional coordinate space, the view matrix comprising vectors indicating the user position within the Gaussian splat scene; determining a projection matrix comprising vectors for a transform of the three-dimensional coordinate space to two-dimensional screen space coordinates for display on a user interface; and projecting the one or more first two-dimensional raster images in a position in the two-dimensional screen space determined by matrix multiplication of the view matrix and projection matrix.

### CROSS-REFERENCE TO RELATED APPLICATIONS

The present application claims the priority benefit of U.S. Provisional Patent Application Serial No. 63/703,696, filed on October 4, 2024, titled “Three-Dimensional Variable Perspective Radiance Field Viewing”. The present application is related to U.S. Patent Application Serial No. 18/740,320, filed on June 11, 2024 and titled “Display of Changing Three-Dimensional Perspectives Based on Position of Target Objects”, which claims the priority benefit of U.S. Patent Application Serial No. 18/478,795, filed on September 29, 2023, titled “Display of Three-Dimensional Scenes with Changing Perspectives”, which claims the priority benefit of U.S. Provisional Patent Application Serial No. 63/412,798, filed on October 3, 2022, titled “Display of Three-Dimensional Scenes with Changing Perspectives”. These applications are hereby incorporated by reference in their entireties, including all appendices.

### FIELD OF INVENTION

The present technology pertains to variable perspectives in radiance field viewing, including three-dimensional volume-rendering methods and applications of the same.

### SUMMARY OF EXEMPLARY EMBODIMENTS

In some embodiments the present technology is directed to a computer-implemented method for displaying three-dimensional viewing content based on a user perspective, the computer-implemented method executable by at least one processor coupled to at least one memory storing instructions for the method to be executed on the processor, the method comprising: receiving point cloud data by one or more structure from motion tools coupled to the at least one processor; creating a Gaussian splat scene by associating Gaussian splats with the point cloud data; generating one or more first two-dimensional raster images from the Gaussian splat scene; deriving a view matrix from a user position in a three-dimensional coordinate space, the view matrix comprising one or more vectors indicating the user position within the Gaussian splat scene; determining a projection matrix comprising one or more vectors for a transform of the three-dimensional coordinate space to two-dimensional screen space coordinates for display on a user interface; and projecting the one or more first two-dimensional raster images in a position in the two-dimensional screen space determined by matrix multiplication of the view matrix and projection matrix.

In various embodiments, the method further comprises associating a virtual camera with a combined camera matrix; determining a transform matrix comprising one or more vectors for an initial position of the virtual camera relative to a point of origin in a virtual space; updating the position of the virtual camera by determining a combined camera matrix for one or more cycles of the determining of the view matrix and the projection matrix; and returning the virtual camera to an initial position and orientation by applying the transform matrix.

The structure from motion tool captures an exterior of a structure, in some embodiments, by orbiting the structure at one or more distances from the structure and one or more altitudes relative to ground. In further embodiments, the structure from motion tool captures the interior of a structure.

To align two or more point cloud datasets, some embodiments of the method use point cloud registration.

In some embodiments, the method includes producing a second two-dimensional raster image having a depth differential relative to the one or more first raster images.

One or more barriers are constructed in the virtual space, using VIDAR or other tools, to prevent or redirect navigation for one or more regions of the virtual space.

To transition from one scene to another, various embodiments of the method include: calculating a translation from a Gaussian splat dataset of the first virtual scene relative to a Gaussian splat dataset of the second virtual scene; copying virtual camera data from the Gaussian splat dataset of the first virtual scene; subtracting the translation from the initial position of the virtual camera; and applying the view matrix and the projection matrix on a next rasterized frame.

The transitioning from the first virtual scene to the second virtual scene being activated by determining the virtual camera to be in one or more zones, the one or more zones comprising one or more geometric shapes comprising coordinates in the virtual space.

These and the various other exemplary methods described herein are generally executable on systems, such as a system comprising one or more sensors, which may include one or more structure from motion tools. The sensors or structure from motion tools are communicatively coupled to one or more processors, which in turn are coupled to one or more memory units that store instructions which, when executed, cause the processor to perform these instructions. The one or more processors are generally coupled to one or more graphical user displays for viewing the virtual scenes. The memory units may be referred to as non-transitory computer-readable storage media having embodied thereon instructions which, when executed by the one or more processors, cause the one or more processors to perform the steps of the methods described herein.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The systems and methods disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1A diagrammatically illustrates an exemplary embodiment for real estate interior stitching of Gaussian splats.

FIG. 1B diagrammatically illustrates an exemplary embodiment for real estate exterior stitching of Gaussian splats.

FIG. 2 diagrammatically illustrates an exemplary embodiment for stitching multiple Gaussian splats for a single object to be viewed in a 3D viewing space.

FIG. 3 diagrammatically represents an example machine in the form of a computer system within which a set of instructions for causing the machine to perform any one or more of the methodologies discussed herein may be executed.

### DETAILED DESCRIPTION

The approaches described in this section could be pursued but are not necessarily approaches that have previously been conceived or pursued. Therefore, unless otherwise indicated, it should not be assumed that any of the approaches described in this section qualify as prior art merely by virtue of their inclusion.

The present disclosure relates to methods of rendering images for three-dimensional viewing. In particular, the present disclosure relates to methods of rendering images using radiance fields, such as Gaussian splats, and of combining the rendered images to enhance the 3D viewing experience.

As used herein, “rasterization” refers to the process of taking an image described in a vector graphics format and converting the image to a raster image, or series of pixels, dots, or lines, which, when displayed together, recreate the image. Rasterization is used to convert 3D models, as well as to convert 2D primitives, such as polygons and line segments, into a rasterized format.

Each pixel, dot, or line in the raster image has a fragment color and an opacity value. The fragment color generally refers to the color value of the individual pixel, dot, or line as calculated in the rasterization process.

Traditional methods of rasterization for 3D viewing include polygon rasterization and radiance field rasterization. Polygon rasterization is often used for 3D models or objects and focuses on modeling surfaces. Geometric shapes and surfaces are represented by a series of polygons. During polygon rasterization, a viewing ray that reflects the user’s view, such as a virtual camera, is applied to the 3D object, yielding a collection of intersections. The intersecting points among these intersections are combined with lighting characteristics and texture characteristics to produce a specific fragment color value. In the case of non-opaque colors, multiple color values are combined to produce the fragment color for a specific viewing ray.

Radiance field rasterization, by contrast, uses point cloud data to determine the shape of objects in a viewing field. The shapes can be modeled as ellipsoids or other three-dimensional figures, but generally do not make use of polygonal surfaces.

Because radiance fields are volumetric, each fragment color is formed through a series of calculations involving a viewing ray and the collective contents of the radiance field through which the viewing ray passes. In general, radiance field rasterization is not influenced by either temporal or environmental lighting.

Gaussian splatting can be used to render radiance fields. As used herein, “Gaussian splatting” refers to an image rendering technique that creates detailed three-dimensional (3D) scenes from photos or videos by representing surfaces as many semi-transparent, soft-edged 3D ellipsoids. Gaussian splatting offers high-quality visualizations with fast rendering speeds. Additionally, Gaussian splatting deals with the direct rendering of volume data without converting the data into surface or line primitives.

In some embodiments, Gaussian splats exist in four dimensions. These 4D Gaussian splats may change shape or other attributes according to a time-dependent function. Additionally, 4D Gaussian splats allow for dynamic scene rendering by using multiple adjacent 3D Gaussians and time-dependent functions or predictive analytics to model how a 3D scene changes over a plurality of timestamps.

It should be noted that while this document generally refers to 3D virtual scenes, it is understood that these systems and methods are enabled for 4D virtual scenes, given the three-dimensional properties inherent in 4D virtual scenes. These embodiments should not be construed as limited to static 3D renderings.

Gaussian splatting begins with data capture, usually in the form of a plurality photos or video frames of a scene taken from various angles. Structure from Motion (SfM) is applied to create a 3D model of a scene or object from the plurality of photos or video frames. A sparse 3D point cloud is created.

Each point in the point cloud is converted into a 3D Gaussian, an ellipsoid or semi-ellipsoid, with properties such as position, scale, orientation, color, and opacity. In some embodiments, these properties are iteratively refined through an optimization process to represent the original scene and its continuous radiance field more accurately. The Gaussian splats are then projected onto a graphical interface and rasterized to blend the splats.

While this document generally refers to rasterization methods using Gaussian splats, other rasterization methods using radiance fields are enabled, including those using Neural Radiance Fields (NeRFs), which are methods of three-dimensional reconstruction using deep learning of a scene from a plurality of images of the scene.

In various embodiments of the present disclosure, Gaussian splats are used to represent either a virtual environment, a virtual object, or a scene combining a virtual environment with one or more virtual objects. Each virtual environment and virtual object is represented by a splat dataset. Virtual objects may be part of a surrounding virtual environment or may be cropped out to stand alone.

Use of radiance fields such as Gaussian splats presents several challenges for three-dimensional viewing platforms.

However, Gaussian splats require a variety of processing steps before they can be used for 3D viewing, especially when the 3D viewing, and thus the rasterization, is relative to the motion of the user. These processing requirements define the image processing workflow.

Various workflows are presented for various use cases. For example, a prepared splat for an interior view of a house will generally require a different workflow than a prepared splat for the exterior view.

The rasterization process for Gaussian splats is also different from that of a basic 3D model. This presents challenges for image presentations that combine basic 3D models with prepared splats and other Gaussian splats.

Gaussian splats present unique challenges for perspective viewing. This is especially true for 3D viewing scenes involving navigation, such as walls, furniture, floors, doors, and ceilings, which require different processes from those of basic 3D models using polygonal shapes. In many basic 3D models, these elements have clearly defined lines that denote their locations and boundaries, whereas Gaussian splats do not.

Lastly, 3D viewing models face challenges with smooth transitions from one scene to another. A person may view a 3D model for the inside of a house and wish to transition from Room A to Room B, each of which is represented by its own set of Gaussian splats. The splats and the transition between splats require different processes from those of basic 3D models.

### Exemplary Embodiments

Exemplary embodiments of the present disclosure enable support for 3D models based on Gaussian splats and other radiance field techniques that update in real time, display in high quality, and transition seamlessly.

The system performs user-relative rasterization of 3D content. Where the 3D content comprises Gaussian splats, either entirely or in combination with 3D polygonal objects, the splats require a variety of processing steps before they are ready to be used. Collectively, these steps are referred to herein as Content Workflow.

A prepared splat is a Gaussian splat that has been processed according to Content Workflow, which may include transforming, cropping, or grouping the raw splat.

According to an exemplary Content Workflow, a Structure from Motion (SfM) tool collects data points from one or more images. The one or more images may be a series of images of the same object or scene captured from different angles. The data points are used to create a point cloud. Gaussian splats are associated with the data points in the point cloud.

The one or more images may also be one or more video frames from a video capture, the one or more video frames taken either at a specified rate (such as one frame per second) or by custom selection, among other methods. For example, a still image may be extracted every second from a video to show discrete scene changes at a continuous rate. Alternatively, scenes may be selected according to preference, such as a specific image of a wall or room in a walkthrough video. Videos may be sped up to reduce overall length and may have their resolution reduced to decrease file size.

Other settings are adjustable, such as shutter time, International Organization for Standardization (ISO) light sensitivity, and white balance.

According to some embodiments, the SfM tool collects 360-degree footage of a location. The image frames from the footage are split into horizontal sections, such as 8 equirectangular images.

One or more transforms may then be applied to the images. For example, the images or point cloud data collected from the images may be cropped (selecting, for example, only the points or splats within an ellipsoidal or rectangular region); cleaned (removing individual splats that may be extraneous or in the wrong place); centered (translating the scene to align with a center or point of origin, such as the surface of a viewing screen); leveled (rotating a scene to make the scene level relative to a center or point of origin and intersecting planes); and exported to a virtual space. In some embodiments, the scene is rotated 180 degrees about an axis to align with the coordinates of the virtual space.

In some embodiments, point cloud registration is used to align two or more point clouds. An iterative closest point (ICP) is used to align two point clouds using overlap. In some such embodiments, an initial rough alignment is received. A general percentage of points that overlap between the two point clouds is also received. The lower this percentage is, the better the initial rough alignment should be. From the initial rough alignment and the general percentage of points that overlap, a 4x4 transform matrix for each point cloud is received.

In various embodiments, Gaussian splats are generated directly from video content. Splats from videos are convertible to Object format (OBJ) models. The splats received as outputs in OBJ format may be surrounded by extra splats that function as a blended photosphere to fill gaps that were not captured in the video content, such as ceilings or sky.

A user device may capture the point cloud data for the Gaussian splats. In some such cases, an augmented reality overlay directs the user on how to collect images from multiple angles. The images are then uploaded to a service that produces mesh-based models, Gaussian splats, and NeRF reconstructions.

Images that are rendered as Gaussian splats are then processed and combined to create a 3D viewable image. The 3D viewable image is added to a viewing experience.

In some embodiments, a drone captures the point cloud data. The drone may include an integrated camera or point cloud capture device, or it may carry a user device that performs the image or point cloud capture. According to one example, a drone captures a video while flying around the exterior of a structure, such as a house, at various altitudes and distances. The recorded footage is converted into still images and a point cloud is drawn from the images using SfM. An algorithm trains and assigns Gaussian splats from the point cloud. In some embodiments, the video length and file size are reduced.

A 3D scene is constructed representing the exterior of the structure with the Gaussian splats. The scene is then leveled and centered. Extraneous Gaussians are removed, and the images are cropped and transformed as desired. The structure may be set against a sphere, ellipsoid, or rectangle, or may have no cropping at all, instead showing the wider neighborhood.

The 3D model is then exported to the viewing platform. In some embodiments, the structure is viewable by a virtual orbital camera. The starting angle, position, and scale can be adjusted on the viewing platform. In some embodiments, a ceiling dome or sky dome is added to fill in if the ceiling or sky was not captured, or if the filled-in image is preferable to the actual recorded image.

An exemplary system includes at least one processor and a memory storing instructions which, when executed by the at least one processor, cause the processor to: receive a Gaussian splat dataset, a view matrix, and a projection matrix; render the Gaussian splat dataset onto a two-dimensional shape; and produce a two-dimensional image of the radiance field on the two-dimensional shape, the two-dimensional image having a perspective relative to a viewer, the perspective being defined by the view matrix and the projection matrix.

In some embodiments, the two-dimensional image has four components: red, blue, green, and an opacity factor. “Alpha” may denote an opacity value for a fragment in the radiance field.

In some embodiments, the rasterizer produces a second 2D array representing depth.

A depth sensor is used, in some embodiments, to track a user position in a physical space. Real-world depth data is used to determine information about the user, including the user’s eye position, hand position, and any movement by the user. One or more vectors are drawn from a position on the user’s person, such as from the user’s eye or hand, toward the virtual space. The one or more vectors and real-world depth data are used to produce a view matrix and a projection matrix. In some embodiments, the view matrix and projection matrix are used to create a 3D parallax relative to the user position in the virtual scene.

In some embodiments, virtual cameras for viewing a 3D model are provided for viewing a virtual model, such as a virtual scene or object. Multiple camera embodiments are enabled, each having a certain mode of translating or navigating the 3D scene.

“Virtual camera” generally refers to the viewport or perspective that reflects a point of view in a virtual scene as seen from a user position. The virtual camera is generally defined to initially point in a chosen direction and to move through the virtual space in various ways, including positional translation, pitch, yaw, and in some instances, roll.

Virtual cameras, in various embodiments, are controlled using smart phones or personal devices, control devices such as a joystick or mouse, or, in some embodiments, by the user’s own body. In some such examples of the latter, one or more vectors, such as from the eye to hand, elbow to hand, or combination, are captured by a depth sensor.

Some or all depth data is obtained, in some embodiments, using video Doppler radar, or VIDAR. In various embodiments, VIDAR detects barriers in a space that are processed and reconstructed as barriers in a virtual scene. For example, heading VIDAR detects virtual barriers in front of a user, such as a wall. Floor VIDAR detects barriers at approximately 90-degrees downward rotation from a heading or user’s viewing perspective, generally indicating a floor.

Some embodiments of the technology include a point-to-fly function, in which users navigate a 3D scene by pointing at the display screen. The 3D perspective changes to give the appearance that the user is flying along a path above virtual ground, with either a fixed or variable height. Similarly, some embodiments include a point-to-walk function, in which users maintain constant height relative to a detected floor. Heading VIDAR may be used to stop forward navigation at barriers in front of the virtual camera. Floor VIDAR is generally used to maintain the constant height relative to the floor.

In some embodiments, navigation produces the effect of rotating scene contents around a center or one or more foci of a scene, viewable by a virtual orbital camera. Additional tools enable authors of 3D scenes to translate and rotate scenes as desired during an authoring phase. Canvases are used to scale objects from real-world size to author-specified size. A Hyperactivity Matrix is used to support accentuation of translational and rotational aspects of 3D scene navigation, thereby enabling hyper-rotation, hyper-zoom, and hyper-translation. In an example, a camera matrix, such as the Combined Camera Matrix described below, is multiplied using matrix multiplication by the Hyperactivity Matrix such that a user who turns only two degrees to the left in a physical space will appear to turn ten degrees to the left in a virtual space. A user who takes one step forward in a physical space may appear to take ten steps forward in the virtual space.

A function, referred to here as a “Gaussian Camera”, parameterizes the inputs, the View Matrix and Projection Matrix, in whatever coordinate system is set for the rasterizer. The coordinate system is referred to herein as the Gaussian Camera Space.

It should be noted that the Gaussian Camera Space is generally referred to by Cartesian coordinates (x, y, z), but may also be referred to by cylindrical coordinates (r, θ, z) or spherical coordinates (r, θ, φ). The coordinate systems may also follow either left-hand or right-hand rules.

In some embodiments, the system uses a scale factor parameter to determine how real-world measurements are scaled for splatting units.

The Gaussian Camera’s position and rotation can be initialized to any location in a Gaussian splat radiance field defined by the Gaussian splat dataset. The author determines the desired initial position and rotation, either or both of which can be specified as inputs in the authoring script. The canvas feature can be applied to the position to ensure the consistency of the initial rendered perspective across different sized displays.

A function referred to here as the Gaussian Camera Adapter determines the user’s position and rotation in a virtual space from the inverse of the view matrix and projection matrix.

In some embodiments, a scene matrix represents a 3D virtual scene having a 3D coordinate space. Virtual objects can be represented with vectors in the 3D virtual space.

In an exemplary embodiment, on each rendered frame, the Gaussian Camera Adapter uses the input matrices (view matrix, projection matrix, and scene matrix) by multiplying them using matrix multiplication to produce a Combined Camera Matrix. The Combined Camera Matrix is used to deviate the Gaussian Camera from its initial position and rotation, producing an updated position and rotation from which to view the radiance field. The updated position and rotation are used to define the Gaussian Camera View Matrix.

An exemplary method for creating a Gaussian Camera View Matrix includes: producing a Combined Camera Matrix from the input matrices using a coordinate space; determining the rotation, translation, and scale factor displacements from a point of origin in a virtual space associated with the coordinate space; associating a virtual camera with the Combined Camera Matrix; determining the rotation, translation, and in some embodiments, scale factor, from a point of origin of the coordinate space; transforming the Gaussian Camera position, rotation, and scale factor based on differences in axis orientations and scale factor; determining a transform matrix that transforms the Gaussian Camera position to the point of origin and returns the rotated position to an unrotated position (initial Neutral Space); assigning the rotation, translation, and in some embodiments, scale factor to the Gaussian camera in a transformed state; and applying an inverse of the transform matrix to move the Gaussian Camera to a new position in Neutral Space, the new position in virtual space having a new point of origin relative to the Gaussian Camera position and rotation; and transforming the Gaussian Camera from Neutral Space back to its own space.

In some embodiments for variable perspective viewing, the projection matrix represents a frustum. The frustum, combined with the view matrix, produces a 3D parallax effect when rendering with the rasterizer.

On each rendering cycle, the rasterizer is called with the Gaussian Camera View Matrix and the Projection Matrix from the Gaussian Camera Adapter to produce a new 2D image and, if needed for VIDAR, a depth map.

The 2D image is copied and blended onto the contents of a frame buffer, a dedicated portion of Random Access Memory (RAM) that holds one or more files with pixels that will be displayed on an image screen at any given moment. The depth data, if used, is normalized and processed by the VIDAR system.

In some embodiments, a splat dataset is interpreted to represent a complete environment. These datasets are referred to as Environment Splats. In general, for Environment Splat datasets, the rasterizer 2D image output is copied and alpha blended onto the frame buffer after any 3D model background is rendered.

Alternatively, a splat dataset is interpreted to represent an object, which may be part of a surrounding environment or may be cropped out to stand alone. This is generally referred to herein as an Object Splat. An exemplary object is a retail product.

Object Splats are generally rendered with alpha blending onto the frame buffer only after the environment, if any, is rendered. In exemplary embodiments, Environment and Object Splats are rendered in two sets, such as Set A and Set B. First, Set A datasets are rendered onto the frame buffer in the order that they are declared in the authoring script. Next, the 3D models are rendered onto the frame buffer. Next, Set B datasets are rendered onto the frame buffer with alpha blending in the order in which they were declared in the authoring script. Authors may thus produce results with 3D models on top of 3D splats or 3D splats on top of 3D models. Additional models can be rendered onto the frame buffer as overlays, as is often the case with logos and other insignia.

### Barriers

“Barriers”, as used herein, generally refers to a type of 3D mesh that is used to constrain virtual camera navigation. Barriers prevent navigation in a virtual space by, for example, moving through a window, which can be difficult to detect using splat depth rendering.

In various embodiments, an authoring tool is used to define barriers of various shapes and geometries, as well as to assign position, rotation, and scale for each barrier.

Barriers can be used in conjunction with or in place of VIDAR depth values. According to one example, when these processes are used in conjunction, the closest values in each set are taken for a particular pixel and point cloud registration is applied.

### Stitching and Transitions

“Stitching”, as used herein, generally refers to aligning two or more Gaussian splat datasets and navigating them in a seamless way in one or more virtual scenes. A plurality of matrices is used to align scenes. The matrices are determined using Content Workflow methods as described above. The rotation and scale from the matrices are applied to each of the datasets as a preprocessing step by, for example, using the Content Workflow methods.

The authoring script can be used to specify the set of splat datasets in a stitch and set the translation matrix for each dataset. One of the datasets is defined as the starting point for navigation and rendering.

Using the dataset translation matrices, viewers in a virtual scene transition from viewing one virtual scene from a particular perspective (position and rotation) to another virtual scene from the equivalent perspective.

To affect this transition, the system calculates the relative translation from the first scene’s splat dataset to the second scene’s splat dataset. The system then copies the virtual camera data from the first dataset and subtracts the relative translation from its initial position. This situates the initial position for the virtual camera in the new dataset at the equivalent initial position that was used in the old dataset.

On the next rendered frame, the camera adapter applies the view matrix and projection matrix. The rasterizer renders a frame in the new dataset equivalent to the last frame rendered in the old dataset. To make the transition visually smooth, the system performs a plurality of iterative rendering cycles with alpha blending.

The rendering of the new dataset becomes progressively more dominant through the plurality of cycles, while the old dataset becomes progressively less dominant. At the end of the blending cycle, only the new dataset is rendered.

In some embodiments, only the present transition is permitted; other transitions are prevented from triggering.

Authors may wish to test transitions between datasets. In some embodiments, testing transitions can be triggered with keystrokes, cursor clicks, and other input actuations. However, when implemented in a virtual space with aligned scenes configured for transition, automatic transitions are triggered using zones.

“Zones,” as used herein, refer to geometric shapes (generally cuboids or ellipsoids) defined using Content Workflow methods and passed to the authoring script. Zones are defined using absolute coordinates of the aligned dataset space. Each dataset can have one or more zones associated with it. Zones can overlap, and gaps can exist in between zones.

Upon import, the system converts the coordinates for the zones into their own Model Space by applying a configurable scale factor, as well as by adjusting for differences in axis orientation.

During navigation, the system calculates the location of a configurable distance in front of the virtual camera in Model Space. This position is used in conjunction with the zones to determine if a transition is warranted.

In an exemplary method, on each rendering cycle, the position is checked to determine which zone the virtual camera lies within, if any. If the position does not fall within any zone, or if it does not fall within a zone designated for transition, no transition is made.

If the position falls within a zone not associated with the current dataset, one of two steps takes place. First, if the position also falls within a zone associated with the current dataset, no transition is made. In the alternative, if the position does not fall within a zone associated with the current dataset, a transition is made to the dataset associated with the new zone. In some embodiments, a transition occurs with a triggering event, such as selection of a transition option, even if the position also falls within a zone associated with the current dataset.

The rasterizer executes using a graphics processing unit (GPU) on data from a Gaussian dataset stored in the GPU.

Stitching, in some embodiments, involves any number or plurality of datasets. The system dynamically loads and unloads datasets to and from the GPU to ensure only the one or two most relevant datasets are loaded at any given time: The current dataset and either the previous dataset or a next likely dataset (if not transitioning), based on a navigational position, direction, and proximity to zones.

### Exemplary Use Cases

In some embodiments, the user experience involves navigating or viewing radiance fields defined by Gaussian splats.

“Navigation” signifies manipulation of a virtual camera using a device such as a smartphone, mouse, or body part to affect a translation, rotation, or scale factor within the radiance field. “Viewing” signifies manipulation of the View Matrix and Projection Matrix based on virtual camera position. The virtual camera position may, in various embodiments, be determined from the position of a user’s body, or body part such as eye or hand, relative to a 3D sensor input. “Viewing” manipulation affects change in perspective to create a 3D parallax effect, or variable perspective viewing. Exemplary 3D viewing experiences use navigation and viewing separately or in combination.

User experience can be described broadly for navigating and viewing both spaces and objects. Spaces can feature walls and objects in near- or distant-fields. Object navigation and viewing is concerned with exploring an object that has been extracted from its environment using Content Workflow cropping methods.

In an exemplary use case for exploring a room inside a structure, an environmental splat dataset is used to represent the viewing environment. A model background may be used for areas such as ceilings that have not been clearly captured.

An input device, such as a smartphone, mouse, or body part with Popscreen is used to navigate using point-to-walk or fixed height point-to-fly. Navigation through walls is prevented by VIDAR.

As used herein, Popscreen generally refers to systems and methods for generating three-dimensional scenes that change with the user’s perspective. Using Popscreen systems and methods, a user may interact with a virtual space or with virtual objects in the virtual space without the need for handheld or wearable devices. An exemplary method for Popscreen is provided in related application U.S. Patent Application No. 18/740,320, filed June 11, 2024, titled “Display of Changing Three-Dimensional Perspectives Based on Position of Target Objects”. The exemplary Popscreen method comprises: demarcating an axis of a three-dimensional space through a surface of a display device, whereby one side of the axis is mapped onto a physical space; receiving, by one or more sensor devices, point cloud data from the physical space, the point cloud data being indicative of one or more target objects; computing a likely shape for each of the one or more target objects based on the plurality of captured data points; calculating a frustum based on the user’s position relative to the one or more sensor devices and, in some embodiments, at least one of the one or more target objects; and displaying, by the display device, a perspective of a three-dimensional virtual scene, the perspective being determined from the calculated frustum.

In some embodiments, a 3D parallax effect is created for objects in a room and updated as the viewer’s eye position changes. In some embodiments, the updated parallax effect is generated using Popscreen methods.

In an exemplary use case for exploring outdoors, a similar method is used: an environmental splat is used to represent the viewing environment; a model may be used for areas such as overhead sky or other areas poorly captured; and point-to-walk or fixed or variable height point-to-fly are used to navigate the scene. The viewing path can be set to be orbital, around an object in the environment, or can follow a path.

Viewing in an outdoor embodiment creates a 3D parallax effect of objects in the environment as the user’s eye position changes.

In exemplary embodiments for object navigation and viewing, the object corresponds to a real-world object. The object could be an entire house or retail item, such as a new car, item of jewelry; or the object could be an artifact in a museum’s collection.

In such embodiments, a 3D model background is created to display behind the object. In some such embodiments, the 3D model comprises a splat, while in others, the 3D background is generated using traditional polygon rasterization.

In some embodiments, the 3D model background is a “shadow box” for additional perspective to Variable Perspective Viewing.

The object, represented by a splat dataset, is cropped according to a content workflow to have its environment removed. Additional models, such as cursors and logos, may be incorporated.

An input device such as a smartphone, mouse, or body part using Popscreen controls navigation around the object and the virtual scene containing the object. Navigation may, for example, be orbital, linear, planar, or multi-planar, and may be affected by scale factor. As outlined above, point-to-fly and point-to-walk navigation are enabled.

Viewing of the object includes creating a 3D parallax effect of the object as the user’s eye position changes. In some embodiments, hyper-rotation is added to accentuate the horizontal or vertical rotation (yaw and pitch, respectively) affected in response to the user’s eye position.

### Detailed Description of the Drawings

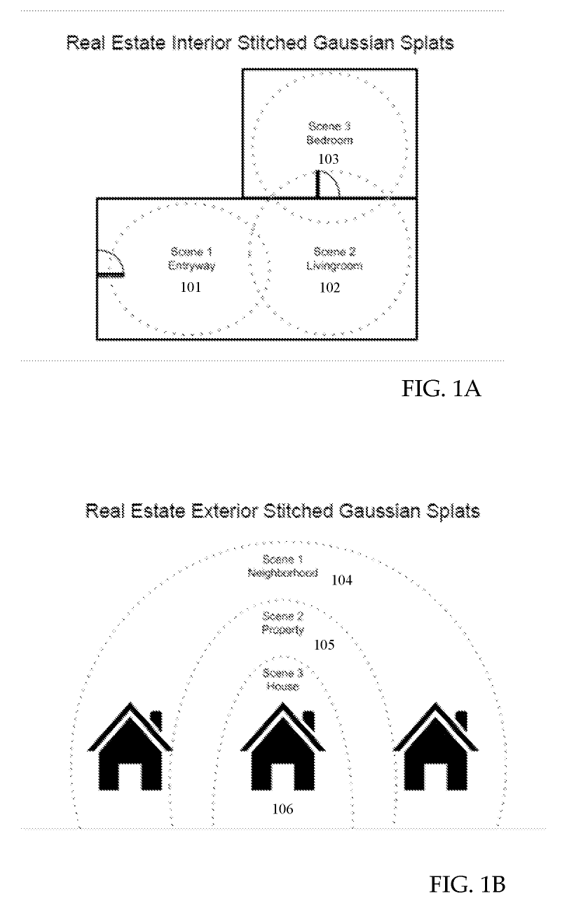

FIG. 1A diagrammatically illustrates an exemplary embodiment for real estate interior stitching of Gaussian splats. Gaussian splats are captured for three rooms: An entryway 101, a living room 102 connected to the entryway 101 and a bedroom 103, and the bedroom 103 itself. The multiple rooms represent a space to be viewed in a 3D viewing space, in this case, for a virtual tour of the interior of a real estate listing.

A user viewing the listing may begin with the Gaussian Camera initialized at an initial position and rotation in the entryway 101. The user may navigate the virtual space by keyboard or other device input or using methods for detecting the user’s body and gestures through point cloud data. Barriers may be constructed for floors and walls within the Gaussian splat scene. The zones for scene transition may be the areas of overlap between the entryway 101 and the living room 102, or between the living room 102 and the bedroom 103. A transition may be activated automatically when the user enters the transition zone or, in some embodiments, when the user enters the zone and sends a signal to actuate transition, such as a click or readable gesture.

FIG. 1B diagrammatically illustrates an exemplary embodiment for real estate exterior stitching of Gaussian splats. Again, multiple Gaussian splats are captured, first of a neighborhood 104 surrounding a house 106 that is the subject of a real estate listing; second, of the property 105 surrounding the house 106, and finally the house 106 that is the subject of the listing itself. The multiple scenes represent a space to be viewed in a 3D viewing space, in this case, for a virtual tour of the exterior of a real estate listing.

As with the embodiment shown in FIG. 1A, the user may begin with the Gaussian Camera initialized to a position and rotation in the neighborhood 104 and may navigate to the property 105 through the virtual space. A transition zone may be defined between two or more scenes, and transition may be triggered automatically or by an actuation signal.

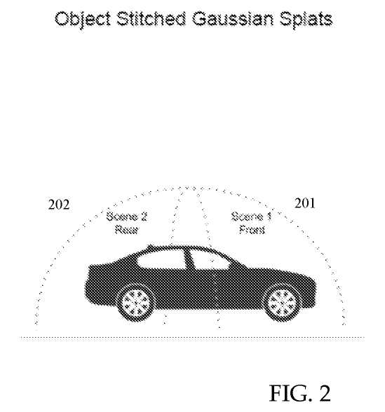

FIG. 2 diagrammatically illustrates an exemplary embodiment for stitching multiple Gaussian splats for a single object to be viewed in a 3D viewing space. Here, two Gaussian splats are captured, first of the front of a vehicle 201 that may be listed for sale, lease, or rent; second of the rear of the vehicle 202. The user may begin with the Gaussian Camera initialized to a position and rotation in Scene 1, the front of the vehicle 201, and may navigate the Gaussian splat scene. Barriers prevent the user from walking through the object. The front of the vehicle 201 and the rear of the vehicle 202 comprise two scenes in virtual space that are stitched together. One or more zones trigger a transition from one to the next, either automatically or by user actuation.

In each of the examples of FIGS. 1A, 1B, and 2, multiple Gaussian splat scenes are stitched together by aligning their Gaussian splat datasets and seamlessly transitioning from one scene to the next using the content workflow methods described herein.

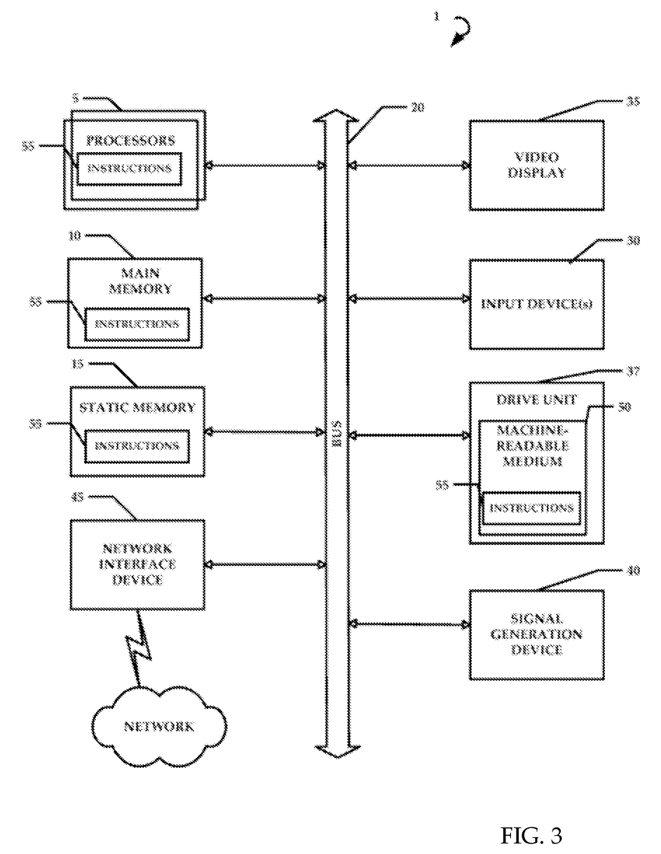

FIG. 3 is a diagrammatic representation of an example machine in the form of a computer system, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system includes a processor or multiple processor(s) (e.g., a central processing unit (CPU), a graphics processing unit (GPU), or both), and a main memory and static memory, which communicate with each other via a bus. The computer system may further include a video display (e.g., a liquid crystal display (LCD)). The computer system may also include an alpha-numeric input device(s) (e.g., a keyboard), a cursor control device (e.g., a mouse), a voice recognition or biometric verification unit (not shown), a drive unit (also referred to as disk drive unit), a signal generation device (e.g., a speaker), and a network interface device. The computer system may further include a data encryption module (not shown) to encrypt data.

The disk drive unit includes a computer or machine-readable medium on which is stored one or more sets of instructions and data structures (e.g., instructions) embodying or utilizing any one or more of the methodologies or functions described herein. The instructions may also reside, completely or at least partially, within the main memory and/or within the processor(s) during execution thereof by the computer system. The main memory and the processor(s) may also constitute machine-readable media.

The instructions may further be transmitted or received over a network via the network interface device utilizing any one of several well-known transfer protocols (e.g., Hyper Text Transfer Protocol (HTTP)). While the machine-readable medium is shown in an example embodiment to be a single medium, the term "computer-readable medium" should be taken to include a single medium or multiple medium (e.g., a centralized or distributed database and/or associated caches and servers) that store the one or more sets of instructions. The term "computer-readable medium" shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term "computer-readable medium" shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the embodiments of the disclosure as described herein.

The computer program instructions may also be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The various embodiments described above are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A computer-implemented method for displaying three-dimensional viewing content based on a user perspective, the computer-implemented method executable by at least one processor coupled to at least one memory storing instructions for the method to be executed on the processor, the method comprising:
receiving point cloud data by one or more structure from motion tools coupled to the at least one processor;
creating a Gaussian splat scene by associating Gaussian splats with the point cloud data;
generating one or more first two-dimensional raster images from the Gaussian splat scene;
deriving a view matrix from a user position in a three-dimensional coordinate space, the view matrix comprising one or more vectors indicating the user position within the Gaussian splat scene;
determining a projection matrix comprising one or more vectors for a transform of the three-dimensional coordinate space to two-dimensional screen space coordinates for display on a user interface; and
projecting the one or more first two-dimensional raster images in a position in the two-dimensional screen space determined by matrix multiplication of the view matrix and projection matrix.

2. The computer-implemented method of claim 1, further comprising:
associating a virtual camera with a combined camera matrix;
determining a transform matrix comprising one or more vectors for an initial position of the virtual camera relative to a point of origin in a virtual space;
updating the position of the virtual camera by determining a combined camera matrix for one or more cycles of the determining of the view matrix and the projection matrix; and
returning the virtual camera to an initial position and orientation by applying the transform matrix.

3. The computer-implemented method of claim 1, further comprising the structure from motion tool capturing an exterior of a structure by orbiting the structure at one or more distances from the structure and one or more altitudes relative to ground.

4. The computer-implemented method of claim 1, further comprising the structure from motion tool capturing the interior of a structure.

5. The computer-implemented method of claim 1, further comprising aligning two or more point clouds using point cloud registration.

6. The computer-implemented method of claim 1, further comprising producing a second two-dimensional raster image, the second two-dimensional image having a depth differential relative to the one or more first raster images.

7. The computer-implemented method of claim 1, further comprising one or more barriers in the virtual space, the one or more barriers preventing navigation in the virtual space.

8. The computer-implemented method of claim 1, further comprising transitioning from a first virtual scene to a second virtual scene by:
calculating a translation from a Gaussian splat dataset of the first virtual scene relative to a Gaussian splat dataset of the second virtual scene;
copying virtual camera data from the Gaussian splat dataset of the first virtual scene;
subtracting the translation from the initial position of the virtual camera; and
applying the view matrix and the projection matrix on a next rasterized frame.

9. The computer-implemented method of claim 8, further comprising the transitioning from the first virtual scene to the second virtual scene being activated by determining the virtual camera to be in one or more zones, the one or more zones comprising one or more geometric shapes comprising coordinates in the virtual space.

10. A system for displaying three-dimensional viewing content based on a user perspective, the system comprising:
at least one structure from motion tool coupled with at least one processor, the at least one processor coupled to at least one memory storing instructions for the method to be executed on the processor, cause the processor to:
receive point cloud data by one or more structure from motion tools coupled to the at least one processor;
create a Gaussian splat scene by associating Gaussian splats with the point cloud data;
generate one or more first two-dimensional raster images from the Gaussian splat scene;
derive a view matrix from a user position in a three-dimensional coordinate space, the view matrix comprising one or more vectors indicating the user position within the Gaussian splat scene;
determine a projection matrix comprising one or more vectors for a transform of the three-dimensional coordinate space to two-dimensional screen space coordinates for display on a user interface; and
project the one or more first two-dimensional raster images in a position in the two-dimensional screen space determined by matrix multiplication of the view matrix and projection matrix.

11. The system of claim 10, the processor further configured to:
associate a virtual camera with a combined camera matrix;
determine a transform matrix comprising one or more vectors for an initial position of the virtual camera relative to a point of origin in a virtual space;
update the position of the virtual camera by determining a combined camera matrix for one or more cycles of the determining of the view matrix and the projection matrix; and
return the virtual camera to an initial position and orientation by applying the transform matrix.

12. The system of claim 10, the structure from motion tool capturing an exterior of a structure by orbiting the structure at one or more distances from the structure and one or more altitudes relative to ground.

13. The system of claim 10, the structure from motion tool capturing an interior of a structure.

14. The system of claim 10, the processor further configured to align two or more point clouds using point cloud registration.

15. The system of claim 10, the processor further configured to produce a second two-dimensional raster image, the second two-dimensional image having a depth differential relative to the one or more first raster images.

16. The system of claim 10, the processor further configured to generate one or more barriers in the virtual space, the one or more barriers preventing virtual navigation in the virtual space.

17. The system of claim 10, the processor further configured to transition from a first virtual scene to a second virtual scene by:
calculating a translation from a Gaussian splat dataset of the first virtual scene relative to a Gaussian splat dataset of the second virtual scene;
copying virtual camera data from the Gaussian splat dataset of the first virtual scene;
subtracting the translation from the initial position of the virtual camera; and
applying the view matrix and the projection matrix on a next rasterized frame.

18. The system of claim 17, the transitioning from the first virtual scene to the second virtual scene being activated by determining the virtual camera to be in one or more zones, the one or more zones comprising one or more geometric shapes comprising coordinates in the virtual space.

19. A non-transitory computer-readable storage medium having embodied thereon instructions which, when executed by a processor, perform the steps of a method, the method comprising:
receiving point cloud data by one or more structure from motion tools coupled to the at least one processor;
creating a Gaussian splat scene by associating Gaussian splats with the point cloud data;
generating one or more first two-dimensional raster images from the Gaussian splat scene;
deriving a view matrix from a user position in a three-dimensional coordinate space, the view matrix comprising one or more vectors indicating the user position within the Gaussian splat scene;
determining a projection matrix comprising one or more vectors for a transform of the three-dimensional coordinate space to two-dimensional screen space coordinates for display on a user interface; and
projecting the one or more first two-dimensional raster images in a position in the two-dimensional screen space determined by matrix multiplication of the view matrix and projection matrix.

20. The non-transitory computer-readable storage medium of claim 19, further comprising:
associating a virtual camera with a combined camera matrix;
determining a transform matrix comprising one or more vectors for an initial position of the virtual camera relative to a point of origin in a virtual space;
updating the position of the virtual camera by determining a combined camera matrix for one or more cycles of the determining of the view matrix and the projection matrix; and
returning the virtual camera to an initial position and orientation by applying the transform matrix.
